(19) United States
(12) Patent Application Publication
(10) Pub. No.: US 2025/0146747 A1
(43) Pub. Date: May 8, 2025

(54) UTILIZING FLUE GAS HEAT FOR CARBON DIOXIDE CAPTURE

(71) Applicant: L'Air Liquide, Societe Anonyme pour l'Etude et l’Exploitation des Procedes Georges Claude, Paris (FR)

(72) Inventors: Vincent LU, Houston, TX (US); Mathieu LECLERC, Champigny-Sur-Marne (FR); Charles BIGNAUD, Champigny-Sur-Marne (FR); Guillaume RODRIGUES, Champigny-Sur-Marne (FR); Richard DUBETTIER, Champigny-Sur-Marne (FR)

(21) Appl. No.: 18/939,272

(22) Filed: Nov. 6, 2024

Related U.S. Application Data
(60) Provisional application No. 63/547,626, filed on Nov. 7, 2023.
(60) Provisional application No. 63/547,623, filed on Nov. 7, 2023.

(51) Int. Cl. F25J 3/06; B01D 53/04; B01D 53/047; B01D 53/22; B01D 53/26

(52) U.S. Cl. CPC F25J 3/067; B01D 53/0462; B01D 53/047; B01D 53/229; B01D 53/261; B01D 2256/22; B01D 2257/504; B01D 2257/80; B01D 2259/65; F25J 2205/40; F25J 2205/64; F25J 2205/80; F25J 2240/02; F25J 2260/80

(57) ABSTRACT

A heat integration method, including providing a hot gas stream, wherein the hot gas stream includes carbon dioxide and at least one gas from the following: carbon monoxide, nitrogen, and oxygen. Recovering waste heat from the hot gas stream by producing a steam stream by indirect heat exchange, and utilizing the steam stream in a carbon capture system, wherein the carbon capture system includes a cryogenic partial condensation step. Wherein the carbon capture system produces a product carbon dioxide stream.

### CROSS REFERENCE TO RELATED APPLICATIONS

This application claims the benefit of priority under 35 U.S.C. § 119 (a) and (b) to U.S. Provisional Patent Application No. 63/547,623, filed Nov. 7, 2023; and U.S. Provisional Patent Application No. 63/547,626, filed on Nov. 7, 2023, the entire contents of which are incorporated herein by reference.

### BACKGROUND

It is often the case that there is no or little steam available at some industrial facilities. In such situations, a CO2 capture system with cryogenic separation, if present, will commonly be driven fully by electricity.

Flue gas is separated into a pure CO2 product stream and a N2 rich off-gas stream by a CO2 capture unit with cryogenic separation. Before being expanded in at least one nitrogen turbine, the pressurized N2 rich off gas stream is preheated against hot water generated by heat recovery from compression machine(s), CO2 capture system with cryogenic separation, or against hot compressed gas from compression machine(s). Chilled water is generated within the carbon capture unit by evaporative cooling in direct contact with a water stream against the expanded nitrogen rich stream. The chilled water is used to chill the inlet gas to the TSA and the desorbed TSA regeneration gas to condense as much water as possible so that it decreases the TSA size.

The hot water generated by heat recovery from compression machine(s) consists of pumps, exchanges and vessels. The hot water is used as a heating source for flue gas pretreatment, vaporization of cryogenic liquid, and to warm the process streams before a turbine which could be located after PSA, after membranes, or after cryogenic partial condensation. The TSA regeneration stream also utilizes the heat from the hot water or electrical heater to warm the stream for the TSA regeneration process.

### SUMMARY

A heat integration method, including providing a hot gas stream, wherein the hot gas stream includes carbon dioxide and at least one gas from the following: carbon monoxide, nitrogen, and oxygen. Recovering waste heat from the hot gas stream by producing a steam stream by indirect heat exchange, and utilizing the steam stream in a carbon capture system, wherein the carbon capture system includes a cryogenic partial condensation step. Wherein the carbon capture system produces a product carbon dioxide stream.

A heat integration method, including providing a hot gas stream, wherein the hot gas stream having carbon dioxide and at least one gas from the following: carbon monoxide, nitrogen, and oxygen. Recovering waste heat from the hot gas stream by producing a steam stream by indirect heat exchange. Introduce the steam stream into a head absorption chiller, thereby producing a chilled water stream. Cooling the hot gas stream to less than 100 F, by utilizing at least a portion of the chilled water stream in indirect heat exchange, and by utilizing quench water in direct heat exchange, thereby producing a cooled gas stream. Introducing the cooled gas stream into a temperature swing adsorption unit, thereby producing a dried gas stream, and introducing the dried gas stream into a cryogenic partial condensation unit, thereby producing a product carbon dioxide stream.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of a carbon dioxide capture system as known in the art.

FIG. 2 is a schematic representation of another carbon dioxide capture system as known in the art.

FIG. 3 is a schematic representation of one aspect of one embodiment, in accordance with one embodiment of the present invention.

FIG. 4 is a schematic representation of one aspect of one embodiment, in accordance with one embodiment of the present invention.

FIG. 5 is a schematic representation of one aspect of one embodiment, in accordance with one embodiment of the present invention.

FIG. 6 is a schematic representation of one aspect of one embodiment, in accordance with one embodiment of the present invention.

FIG. 7 is a schematic representation of a carbon dioxide capture system, in accordance with one embodiment of the present invention.

FIG. 8 is a schematic representation of another carbon dioxide capture system, in accordance with one embodiment of the present invention.

FIG. 9 is a schematic representation of another carbon dioxide capture system, in accordance with one embodiment of the present invention.

FIG. 10 is a schematic representation of another carbon dioxide capture system, in accordance with one embodiment of the present invention.

FIG. 11 is a schematic representation of one aspect of one embodiment, in accordance with one embodiment of the present invention.

### ELEMENT NUMBERS

100=hot flue gas stream
101=quench
102=second cooled flue gas stream
103=flue gas compressor
104=compressed flue gas stream
105=first heat exchanger
106=third cooled flue gas stream
107=combined cooled flue gas stream
108=temperature swing adsorption unit
109=fourth cooled flue gas stream
110=pressure swing adsorption unit
111=fifth cooled flue gas stream
112=PSA tail gas compression unit
113=compressed PSA tail gas stream
114=cryogenic separation unit
115=carbon dioxide product stream
116=TSA regeneration gas stream
117=second chilled water stream
118=first chilled water return stream
119=chilled water generator
120=off-gas
121=chilled water stream
122=first chilled water stream
123=third heat exchanger
124=third heat exchanger hot heating stream
125=third heat exchanger cool heating stream
126=second chilled water return stream
127=PSA off-gas stream
128=off-gas expander
129=expanded PSA off-gas stream
130=hot water generator
131=hot water to user heat transfer
132=user heat transfer device
133=cooled water from user heat transfer
301=low-pressure saturated steam generator
302=cooled flue gas stream (to cryogenic carbon capture unit)
303=pressurized process condensate stream
304=low-pressure saturated steam stream
305=low-pressure saturated steam heat exchanger
306=low-pressure process condensate stream
307=condensate pump
308=cooled user heat transfer medium stream
309=warmed user heat transfer medium stream
401=intermediate temperature flue gas stream
402=hot water generator
403=warmed pressurized process stream
501=low-pressure steam superheater
502=intermediate temperature flue gas stream
503=first warmed pressurized process condensate stream
504=second warmed pressurized process condensate stream
505=superheated low-pressure steam stream
506=superheated low-pressure saturated steam heat exchanger
507=cooled user heat transfer medium stream
508=warmed user heat transfer medium stream
509=supplemental low-pressure condensate stream
510=combined low-pressure condensate stream
701=heat recover steam generator
702=first cooled flue gas stream
703=low-pressure steam stream
705=process condensate stream
706=cryogenic liquid stream
707=vaporized cryogenic stream
708=fourth heat exchanger
709=third chilled water return stream
710=quench water stream
711=chilled quench water stream
712=TSA off-gas stream
714=cryogenic off-gas stream
715=fifth heat exchanger
716=hot cryogenic off-gas stream
717=expander
718=expanded cryogenic off-gas stream
719=second heat exchanger
720=hot heat integration fluid
721=cool heat integration fluid
801=low-pressure steam stream
802=first low-pressure steam stream
803=second low-pressure steam stream
804=PSA off-gas heater
805=first process condensate stream
806=second process condensate stream
807=regeneration gas heat exchanger
808=heated PSA off-gas
809=membrane separation unit
810=second TSA regeneration gas stream
811=TSA regeneration gas compressor
812=high-pressure TSA regeneration gas
814=combined process condensate stream
815=heated TDS regeneration gas stream
816=seventh heat exchanger
817=further heated flue gas stream
818=sixth heat exchanger
819=heated PSA off-gas stream
820=(at least a portion of) second cooled flue gas stream
820=pretreatment filter
821=treated flue gas stream
909=membrane separation unit
910=residue stream
911=permeate stream
912=eighth heat exchanger
913=heated residue stream
914=residue stream expander
915=expanded residue stream
916=ninth heat exchanger
917=heated permeate stream
918=process condensate stream
919=product carbon dioxide compressor
920=compressed carbon dioxide product stream
921=tenth heat exchanger
922=cold cooling fluid stream
923=warm cooling fluid stream
924=densified carbon dioxide product stream
925=densified carbon dioxide product stream pump
926=pressurized densified carbon dioxide product stream

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The invention is related to carbon dioxide (CO2) capture by a cryogenic process, performed on flue gas. The flue gas may be from burner combustion in industrial facilities such as steel production and cement and lime production. The carbon capture unit typically comprises a pretreatment system, a temperature swing adsorption (TSA) unit, a pressure swing adsorption (PSA) unit, compression units, and a cryogenic separation section. The carbon dioxide capture unit is often driven by electricity power only. However, for some specific application, when waste heat is available, steam can be generated and utilized within the carbon dioxide capture unit.

The term “temperature swing adsorption” (TSA) unit is well known to the skilled artisan, but as used herein, a non-limiting definition is a separation process where a solid adsorbent is used to selectively capture a specific component from a gas mixture by cycling between adsorption (at a low temperature) and desorption (at a high temperature).

The term “pressure swing adsorption” (PSA) unit is well known to the skilled artisan, but as used herein, a non-limiting definition is separation process where a solid adsorbent is used to selectively capture a specific component from a gas mixture by cycling between adsorption (at a higher pressure) and desorption (at a lower pressure).

In some industrial processes, the waste heat in the flue gas is not fully utilized. The temperature of the flue gas may be as high as 400 to 500 deg C. To capture the CO2 in the flue gas, the temperature of the flue gas must be cooled to a suitable temperature for the pretreatment equipment. It is common to use a quench unit to cool the flue gas while removing bulk of water in it. However, the hotter the flue gas, the more cooling water the quench process would consume, and the bigger the quench unit it will require. In addition, the available heat is lost.

To increase the efficiency of the overall integration between the process of the emitter and the carbon capture unit, low-pressure steam may be generated from the heat available in the flue gas. The generated steam can be used to generate chilled water via heat absorption. Due to the abundant amount of steam available, this integration not only could eliminate the direct contact chilled water tower, but also enable the possibility of utilizing chilled water at other possible locations within the unit.

The generated steam can also be used as a heat source to various users within the carbon capture units. This use of steam can eliminate the hot water generation loop (pumps, vessel, heat exchangers) integrated with the compressors. This integration reduces the power consumption of the said compressor as tighter approach and cooler water medium temperature can be used at the interstage coolers. By using low-pressure steam as a heating source instead of hot water, the supplemental electrical heater for the TSA regeneration can be eliminated, and nitrogen rich stream can be heated to a higher temperature before the nitrogen turbine. Therefore, the nitrogen turbine is able to increase its power generation capacity.

It is proposed to use the low-pressure steam generated from the waste heat as a heat source in the carbon capture unit or from the waste heat to generate chilled water through heat absorption chillers.

In one embodiment, the present invention comprises generating low-pressure steam by capturing the waste heat of the flue gas with a steam generation device(s). The steam generation devices can be arranged in series with the function of hot water generation and low-pressure saturation steam generation. Chilled water is generated via heat absorption chiller(s) with the steam generated as a regeneration medium. The chilled water may be run in a loop comprising the heat absorption chiller. The chilled water is sent to one or more of the following:
the flue gas chiller located before the TSA and/or sent to the regen gas chiller located after the TSA regen gas cooler and/or
the quench water chiller located after the quench cooler and/or.
the booster chiller located before the booster, and/or.
the CO2 condenser in case of liquid CO2 production.

In another embodiment, the present invention comprises a system wherein the low-pressure steam generated is used as heating sources in the cryogenic carbon capture unit. The condensed process condensates from each user in the cryogenic carbon capture unit are recycled in the steam generation loop.

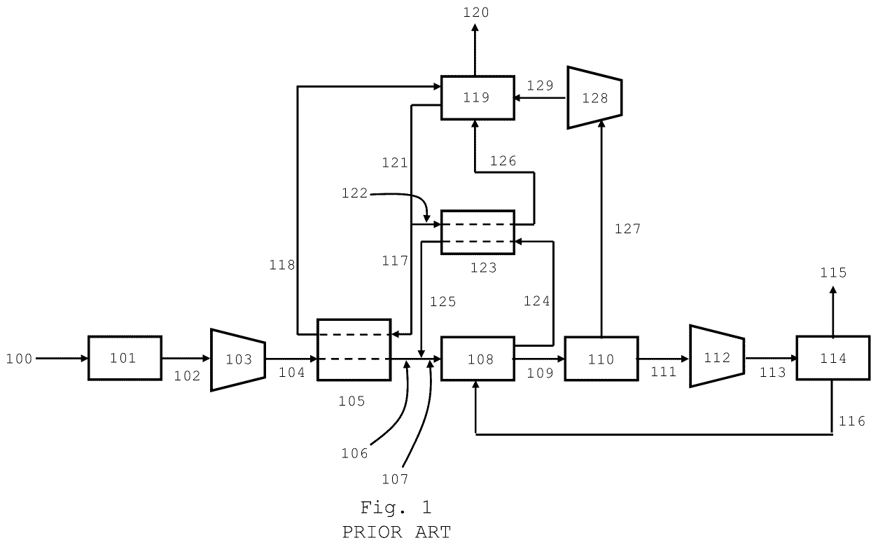

Turning to FIG. 1, an illustration of a system as is known in the art is presented. Hot flue gas stream 100 is introduce into quench 101, thereby producing second cooled flue gas stream 102. Second cooled flue gas stream 102 is introduced into flue gas compressor 103, thereby producing compressed flue gas stream 104. Compressed flue gas stream 104 and second chilled water stream 117 are introduced into first heat exchanger 105, thereby exchanging heat and producing third cooled flue gas stream 106 and first chilled water return stream 118. Third cooled flue gas stream 106 is combined with third heat exchanger cool heating stream 125 thereby producing combined cooled flue gas stream 107. Combined cooled flue gas stream 107 is introduced into temperature swing adsorption unit 108, thereby producing fourth cooled flue gas stream 109 and third heat exchanger hot heating stream 124. Fourth cooled flue gas stream 109 is introduced into pressure swing adsorption unit 110, thereby producing fifth cooled flue gas stream 111 and PSA off-gas stream 127. Fifth cooled flue gas stream 111 is introduced into PSA tail gas compression unit 112, thereby producing compressed PSA tail gas stream 113. Compressed PSA tail gas stream 113 is introduced into cryogenic separation unit 114, thereby producing carbon dioxide product stream 115, and TSA regeneration gas stream 116. First chilled water return stream 118, expanded PSA off-gas stream 129 and second chilled water return stream 126 are introduced into chilled water generator 119, thereby producing off-gas stream 120 and chilled water stream 121. Chilled water stream 121 is split into first chilled water stream 122 and second chilled water stream 117. First chilled water stream 122 and third heat exchanger hot heating stream 124 are introduced into third heat exchanger 123, thereby producing third heat exchanger cool heating stream 125 and second chilled water return stream 126. PSA off-gas stream 127 is introduced into off-gas expander 128, thereby producing expanded PSA off-gas stream 129

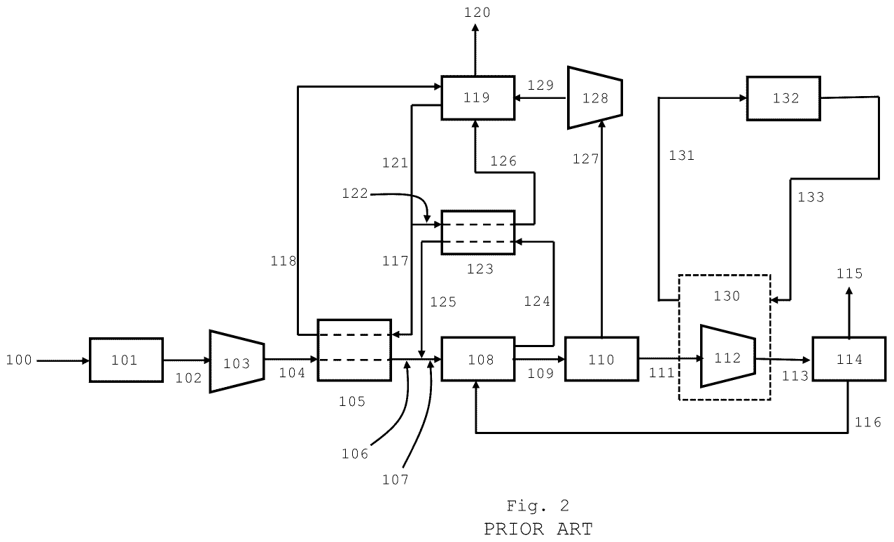

Turning to FIG. 2, another illustration of a system as is known in the art is presented. Hot flue gas stream 100 is introduced into quench 101, thereby producing second cooled flue gas stream 102. Second cooled flue gas stream 102 is introduced into flue gas compressor 103, thereby producing compressed flue gas stream 104. Compressed flue gas stream 104 and second chilled water stream 117 are introduced into first heat exchanger 105, thereby exchanging heat and producing third cooled flue gas stream 106 and first chilled water return stream 118. Third cooled flue gas stream 106 is combined with third heat exchanger cool heating stream 125 thereby producing combined cooled flue gas stream 107. Combined cooled flue gas stream 107 is introduced into temperature swing adsorption unit 108, thereby producing fourth cooled flue gas stream 109 and third heat exchanger hot heating stream 124. Fourth cooled flue gas stream 109 is introduced into pressure swing adsorption unit 110, thereby producing fifth cooled flue gas stream 111 and PSA off-gas stream 127. Fifth cooled flue gas stream 111 is introduced into PSA tail gas compression unit 112 thereby producing compressed PSA tail gas stream 113.

Compressed PSA tail gas stream 113 is introduced into cryogenic separation unit 114, thereby producing carbon dioxide product stream 115, and TSA regeneration gas stream 116. PSA tail gas compression unit 112 exchanges heat within hot water generator 130. Cooled water from user heat transfer 133 is heated within hot water generator 130, thereby producing hot water to user heat transfer 131. Hot water to user heat transfer 131 then enters user heat transfer device, wherein it exchanges heat with a user heat transfer stream (not shown), thereby producing cooled water from user heat transfer 133. First chilled water return stream 118, expanded PSA off-gas stream 129 and second chilled water return stream 126 are introduced into chilled water generator 119, thereby producing off-gas stream 120 and chilled water stream 121. Chilled water stream 121 is split into first chilled water stream 122 and second chilled water stream 117, thereby producing third heat exchanger cool heating stream 125 and second chilled water return stream 126. PSA off-gas stream 127 is introduced into off-gas expander 128, thereby producing expanded PSA off-gas stream 129.

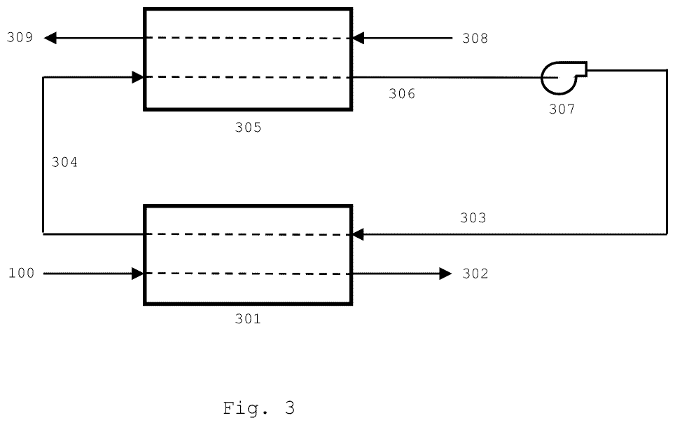

Turning to FIG. 3, an illustration of an aspect of one embodiment of the present invention is shown. Hot flue gas stream 100 is introduced into low-pressure saturated steam generator 301 stream 302, which is to be sent to a cryogenic carbon capture unit (below), and low-pressure saturated steam stream 304. Low-pressure saturated steam stream 304 is then sent to low-pressure saturated steam heat exchanger 305 along with cooled user heat transfer medium stream 308, thereby producing low-pressure process condensate stream 306 and warmed user heat transfer medium stream 309. Low-pressure process condensate stream 306 is then pressurized in condensate pump 307, thereby producing pressurized process condensate stream 303. Thus, some of the waste heat from hot flue gas stream 100 is captured in low-pressure saturated steam stream 304 and integrated in the carbon capture system. The condensed process condensates from each user in the cryogenic carbon capture unit may be recycled into the steam generation loop.

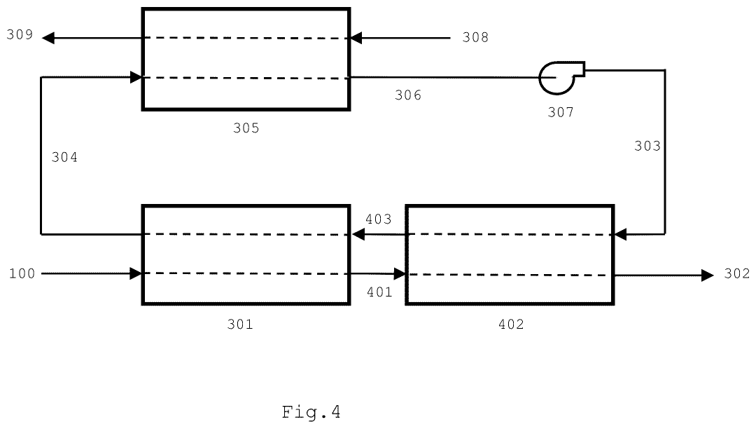

Turning to FIG. 4, an illustration of an aspect of another embodiment of the present invention is shown. Hot flue gas stream 100 is introduced into low-pressure saturated steam generator 301 along with warmed pressurized process stream 403, thereby producing intermediate temperature flue gas stream 401 and low-pressure saturated steam stream 304. Low-pressure saturated steam stream 304 is then sent to low-pressure saturated steam heat exchanger 305 along with cooled user heat transfer medium stream 308, thereby producing low-pressure process condensate stream 306 and warmed user heat transfer medium stream 309. Low-pressure process condensate stream 306 is then pressurized in condensate pump 307, pressurized process condensate stream 303. Intermediate temperature flue gas stream 401 and pressurized process condensate stream 303 are then introduced into hot water generator 402, thereby producing warmed pressurized process stream 403 and cooled flue gas stream 302, which is to be sent to a cryogenic carbon capture unit (below). Thus, as with the above system, some of the waste heat from hot flue gas stream 100 is captured in low-pressure saturated steam stream 304, however in this system additional lower grade heat is captured in hot water generator 402 and integrated in the carbon capture system. The condensed process condensates from each user in the cryogenic carbon capture unit may be recycled into the steam generation loop.

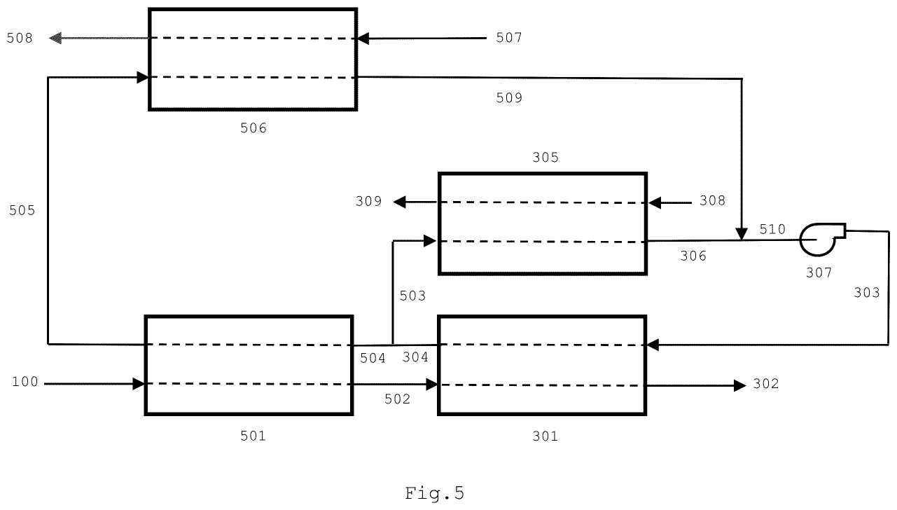

Turning to FIG. 5, an illustration of an aspect of another embodiment of the present invention is shown. Hot flue gas stream 100 is introduced into low-pressure steam superheater 501 along with second warmed pressurized process condensate stream 504, thereby producing superheated low-pressure steam stream 505 along with intermediate temperature flue gas stream 502. Intermediate temperature flue gas stream 502 is introduced into low-pressure saturated steam generator 301 along with pressurized process condensate stream 303, thereby producing cooled flue gas stream 302 and low-pressure saturated steam stream 304. Superheated low-pressure saturated steam stream 505 is then sent to low-pressure saturated superheated low-pressure saturated steam heat exchanger 506 along with cooled user heat transfer medium stream 507, thereby producing supplemental low-pressure condensate stream 509 and warmed user heat transfer medium stream 508. At least a portion of low-pressure saturated steam stream 304, first warmed pressurized process condensate stream 503, is introduced into low-pressure saturated steam heat exchanger 305. Along with first warmed pressurized process condensate stream 503, cooled user heat transfer medium stream 308 is introduced into low-pressure saturated steam heat exchanger 305 thereby producing warmed user heat transfer medium stream 309 and low-pressure process condensate stream 306. Low-pressure process condensate stream 306 is combined with supplemental low-pressure condensate stream 509, thereby producing combined low-pressure condensate stream 510. Combined low-pressure condensate stream 510 is then pressurized in condensate pump 307, pressurized process condensate stream 303. Thus, as with the above systems, some of the waste heat from hot flue gas stream 100 is captured in low-pressure saturated steam stream 304, however in this system and additional higher grade heat is captured in low-pressure steam superheater 501 and integrated in the carbon capture system. The condensed process condensates from each user in the cryogenic carbon capture unit may be recycled into the steam generation loop.

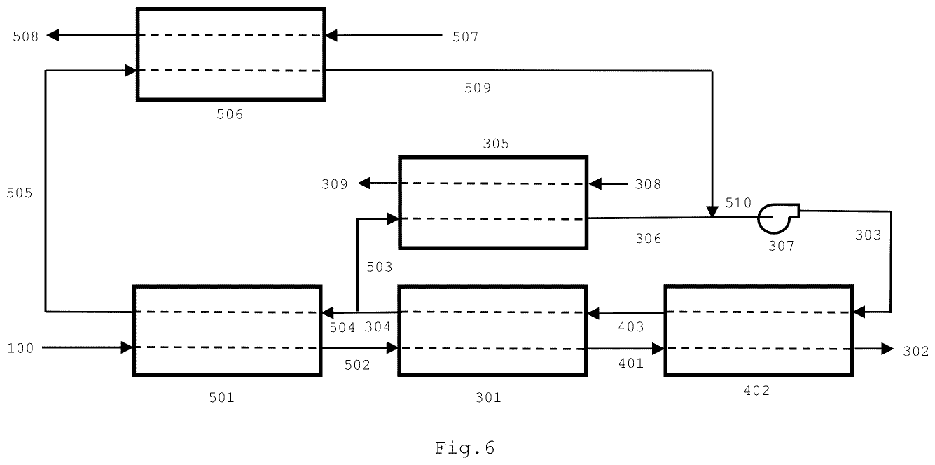

Turning to FIG. 6, an illustration of an aspect of another embodiment of the present invention is shown. Hot flue gas stream 100 is introduced into low-pressure steam superheater 501 along with second warmed pressurized process condensate stream 504, thereby producing superheated low-pressure steam stream 505 along with intermediate temperature flue gas stream 502. Intermediate temperature flue gas stream 502 is introduced into low-pressure saturated steam generator 301 along with warmed pressurized process stream 403, thereby producing intermediate temperature flue gas stream 401 and low-pressure saturated steam stream 304 Superheated low-pressure saturated steam stream 505 is then sent to low-pressure saturated superheated low-pressure saturated steam heat exchanger 506 along with cooled user heat transfer medium stream 507, thereby producing supplemental low-pressure condensate stream 509 and warmed user heat transfer medium stream 508. At least a portion of low-pressure saturated steam stream 304, first warmed pressurized process condensate stream 503, is introduced into low-pressure saturated steam heat exchanger 305. Along with first warmed pressurized process condensate stream 503, cooled user heat transfer medium stream 308 is introduced into low-pressure saturated steam heat exchanger 305 thereby producing warmed user heat transfer medium stream 309 and low-pressure process condensate stream 306. Low-pressure process condensate stream 306 is combined with supplemental low-pressure condensate stream 509, thereby producing combined low-pressure condensate stream 510. Combined low-pressure condensate stream 510 is then pressurized in condensate pump 307, pressurized process condensate stream 303. Pressurized process condensate stream 303 is introduced into hot water generator 402 along with intermediate temperature flue gas stream 401, thereby producing warmed pressurized process stream 403 and cooled flue gas stream 302. Thus, as with the above systems, some of the waste heat from hot flue gas stream 100 is captured in low-pressure saturated steam stream 304, however in this system and additional lower grade heat is captured in hot water generator 402 and additional higher grade heat is captured in low-pressure steam superheater 501 and integrated in the carbon capture system. The condensed process condensates from each user in the cryogenic carbon capture unit may be recycled into the steam generation loop.

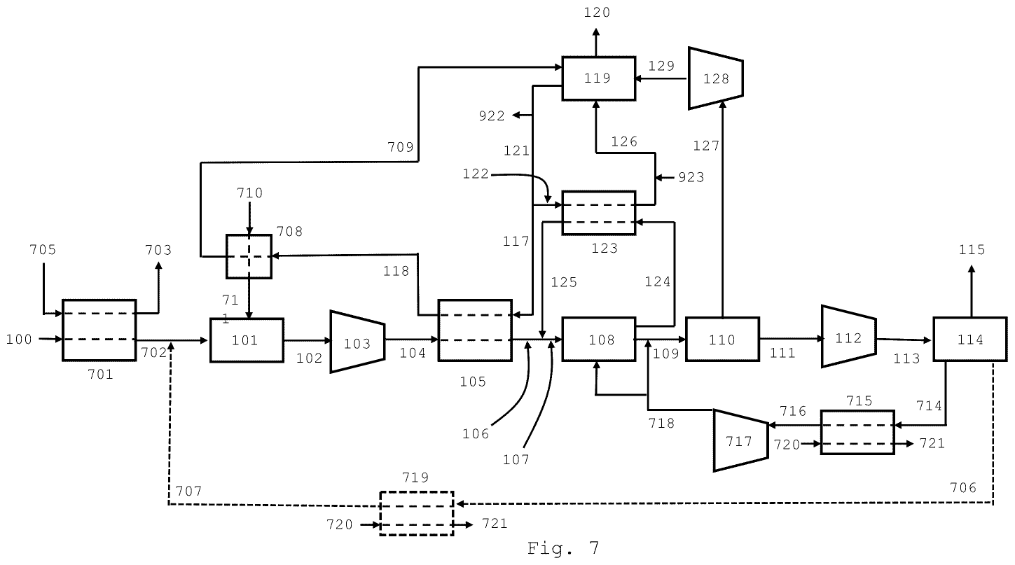

Turning to FIG. 7, an illustration of a system in accordance with the present invention is presented. Hot flue gas stream 100 and process condensate stream 705 are introduced into heat recovery steam generator 701, thereby producing first cooled flue gas stream 702 and low-pressure steam stream 703. First cooled flue gas stream 702, optionally vaporized cryogenic stream 707, and chilled quench water stream 711 are introduced into quench 101, thereby producing second cooled flue gas stream 102. Second cooled flue gas stream 102 is introduced into flue gas compressor 103, thereby producing compressed flue gas stream 104. Compressed flue gas stream 104 and second chilled water stream 117 are introduced into first heat exchanger 105, thereby exchanging heat and producing third cooled flue gas stream 106 and first chilled water return stream 118.

First chilled water return stream 118 and quench water stream 710 enter fourth heat exchanger 708, thereby producing third chilled water return stream 709 and chilled quench water stream 711. Third cooled flue gas stream 106 is combined with third heat exchanger cool heating stream 125 thereby producing combined cooled flue gas stream 107. Combined cooled flue gas stream 107 is introduced into temperature swing adsorption unit 108, thereby producing fourth cooled flue gas stream 109 and third heat exchanger hot heating stream 124. Fourth cooled flue gas stream 109, and optionally expanded cryogenic off-gas stream 718, is introduced into pressure swing adsorption unit 110, thereby producing fifth cooled flue gas stream 111 and PSA off-gas stream 127. Fifth cooled flue gas stream 111 is introduced into PSA tail gas compression unit 112, thereby producing compressed PSA tail gas stream 113. Compressed PSA tail gas stream 113 is introduced into cryogenic separation unit 114, thereby producing carbon dioxide product stream 115, optionally cryogenic off-gas stream 714, and optionally cryogenic liquid stream 706. Third chilled water return stream 709, expanded PSA off-gas stream 129 and second chilled water return stream 126 are introduced into chilled water generator 119, thereby producing off-gas stream 120 and chilled water stream 121. Chilled water stream 121 is split into first chilled water stream 122 and second chilled water stream 117. First chilled water stream 122 and third heat exchanger hot heating stream 124 are introduced into third heat exchanger 123 thereby producing third heat exchanger cool heating stream 125 and second chilled water return stream 126. PSA off-gas stream 127 is introduced into off-gas expander 128, thereby producing expanded PSA off-gas stream 129.

Cryogenic liquid stream 706, if utilized, and hot heat integration fluid 720 are introduced into second heat exchanger 719, thereby producing vaporized cryogenic stream 707 and cool heat integration fluid 721. Cryogenic off-gas stream 714, if utilized, and hot heat integration fluid 720 are introduced into fifth heat exchanger 715, thereby producing hot cryogenic off-gas stream 716 and cool heat integration fluid 721. Hot cryogenic off-gas stream 716 is introduced into expander 717, thereby producing expanded cryogenic off-gas stream 718. Expanded cryogenic off-gas stream 718 is split into TSA regeneration gas stream 116 and the remainder being combined with fourth cooled flue gas stream 109 prior to being introduced into pressure swing adsorption unit 110.

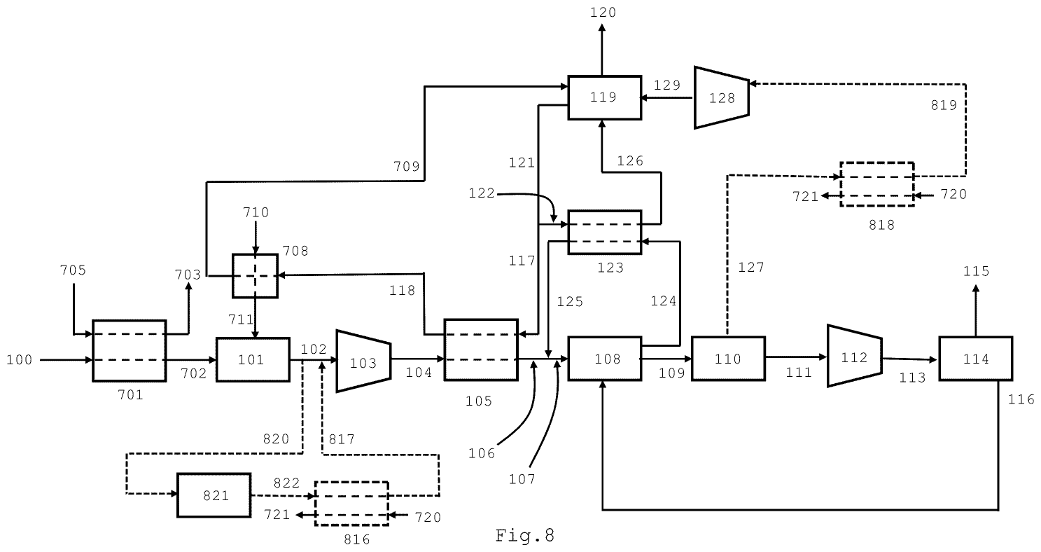

Turning to FIG. 8, an illustration of a system in accordance with the present invention is presented. Hot flue gas stream 100 and process condensate stream 705 are introduced into heat recovery steam generator 701, thereby producing first cooled flue gas stream 702 and low-pressure steam stream 703. First cooled flue gas stream 702 and chilled quench water stream 711 are introduced into quench 101, thereby producing second cooled flue gas stream 102. Optionally, at least a portion 820 of second cooled flue gas stream 102 may be directed to pretreatment filter 821, thereby producing treated flue gas stream 822. Treated flue gas stream 822 and hot heat integration fluid 720 are introduced into seventh heat exchanger 816, thereby producing further heated flue gas stream 817 and cool heat integration fluid 721. Further heated flue gas stream 817, is combined with any un-diverted portion of second cooled flue gas stream 102, and then introduced into flue gas compressor 103, thereby producing compressed flue gas stream 104. Compressed flue gas stream 104 and second chilled water stream 117 are introduced into first heat exchanger 105, thereby exchanging heat and producing third cooled flue gas stream 106 and first chilled water return stream 118.

First chilled water return stream 118 and quench water stream 710 enter fourth heat exchanger 708, thereby producing third chilled water return stream 709 and chilled quench water stream 711. Third cooled flue gas stream 106 is combined with third heat exchanger cool heating stream 125 thereby producing combined cooled flue gas stream 107. Combined cooled flue gas stream 107 and TSA regeneration gas stream 116 are introduced into temperature swing adsorption unit 108, thereby producing fourth cooled flue gas stream 109 and third heat exchanger hot heating stream 124. Fourth cooled flue gas stream 109 is introduced into pressure swing adsorption unit 110, thereby producing fifth cooled flue gas stream 111 and PSA off-gas stream 127. Fifth cooled flue gas stream 111 is introduced into PSA tail gas compression unit 112, thereby producing compressed PSA tail gas stream 113. Compressed PSA tail gas stream 113 is introduced into cryogenic separation unit 114, thereby producing carbon dioxide product stream 115, and TSA regeneration gas stream 116. Third chilled water return stream 709, expanded PSA off-gas stream 129 and second chilled water return stream 126 are introduced into chilled water generator 119, thereby producing off-gas stream 120 and chilled water stream 121. Chilled water stream 121 is split into first chilled water stream 122 and second chilled water stream 117. First chilled water stream 122 and third heat exchanger hot heating stream 124 are introduced into third heat exchanger 123 thereby producing third heat exchanger cool heating stream 125 and second chilled water return stream 126. PSA off-gas stream 127 and hot heat integration fluid 720 are introduced into sixth heat exchanger 818, thereby producing heated PSA off-gas stream 819 and cool heat integration fluid 721. Heated PSA off-gas stream 819 is introduced into off-gas expander 128, thereby producing expanded PSA off-gas stream 129.

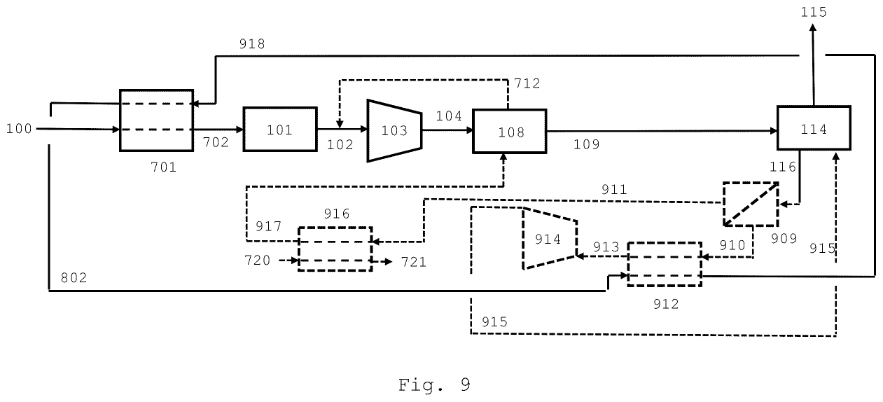

Turning to FIG. 9, an illustration of a system in accordance with the present invention is presented. Hot flue gas stream 100 and process condensate stream 918 are introduced into heat recovery steam generator 701, thereby producing first cooled flue gas stream 702 and low-pressure steam stream 802. First cooled flue gas stream 702 is introduced into quench 101, thereby producing second cooled flue gas stream 102. Second cooled flue gas stream 102 is combined with TSA off-gas stream 712 and introduced into flue gas compressor 103, thereby producing compressed flue gas stream 104. Compressed flue gas stream 104 and heated permeate stream 917 are introduced into temperature swing adsorption unit 108, thereby producing fourth cooled flue gas stream 109 and TSA off-gas (desorbed regeneration) stream 712. Fourth cooled flue gas stream 109 and expanded residue stream 915 are introduced into cryogenic separation unit 114, thereby producing carbon dioxide product stream 115, and TSA regeneration gas stream 116. TSA regeneration gas stream 116 enters membrane separation unit 909, thereby producing permeate stream 911 and residue stream 910. Residue stream 910 and low-pressure steam stream 802 are introduced into eighth heat exchanger 912, thereby producing process condensate stream 918 and heated residue stream 913. Heated residue stream 913 is introduced into residue stream expander 914, thereby producing expanded residue stream 915. Permeate stream 911 and hot heat integration fluid 720 are introduced into ninth heat exchanger 916, thereby producing heated permeate stream 917 and cool heat integration fluid 721.

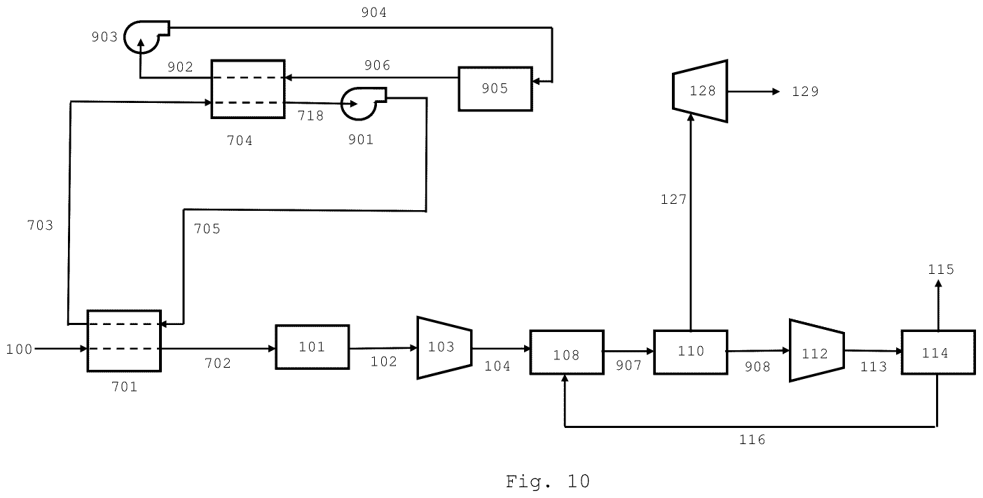

Turning to FIG. 10, an illustration of a system in accordance with the present invention is presented. Hot flue gas stream 100 and pressurized condensate stream 705 are introduced into heat recovery steam generator 701, thereby producing first cooled flue gas stream 702 and low-pressure steam stream 703. Low-pressure steam stream 703 and heated chilled water stream 906 are introduced into absorption chiller 704, thereby producing chilled water stream 902 and process condensate stream 718. Absorption chiller 704 may be any appropriate type known to the art. Chilled water stream 902 is pressurized in chilled water pump 903, thereby producing pressurized chilled water stream 904. Pressurized chilled water stream 904 is then utilized by chilled water users in carbon capture unit 905, which returns heated chilled water stream 906. Process condensate stream 718 is pressurized in condensate pump 901, thereby producing pressurized condensate stream 705.

First cooled flue gas stream 702 is introduced into quench 101, thereby producing second cooled flue gas stream 102. Second cooled flue gas stream 102 is introduced into flue gas compressor 103, thereby producing compressed flue gas stream 104. Compressed flue gas stream 104 is introduced into temperature swing adsorption unit 108, thereby producing third cooled flue gas stream 907. Third cooled flue gas stream 907 is introduced into pressure swing adsorption unit 110, thereby producing fourth cooled flue gas stream 908 and PSA off-gas stream 127. Fourth cooled flue gas stream 908 is introduced into PSA tail gas compression unit 112, thereby producing compressed PSA tail gas stream 113. Compressed PSA tail gas stream 113 is introduced into cryogenic separation unit 114, thereby producing carbon dioxide product stream 115, and TSA regeneration gas stream 116. PSA off-gas stream 127 is introduced into off-gas expander 128, thereby producing expanded PSA off-gas stream 129.

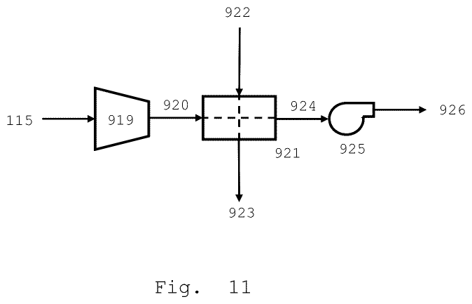

Turning to FIG. 11, another embodiment of the present invention is presented. In any of the above embodiments, carbon dioxide product stream 115 may enter product carbon dioxide compressor 919, thereby producing compressed carbon dioxide product steam 920. Compressed carbon dioxide product steam 920 along with cold cooling fluid stream 922 enter tenth heat exchanger 921, thereby producing densified carbon dioxide product stream 924 and warm cooling fluid stream 923. Densified carbon dioxide product stream 924 is introduced into densified carbon dioxide product stream pump 925, thereby producing pressurized densified carbon dioxide product stream 926. In one embodiment, cold cooling fluid stream 922 is at least a portion of chilled water stream 121, and warm cooling fluid stream 923 is returned to chilled water generator 119.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A heat integration method, comprising:
providing a hot gas stream, wherein the hot gas stream comprises carbon dioxide and at least one gas from the following: carbon monoxide, nitrogen, and oxygen,
recovering waste heat from the hot gas stream by producing a steam stream by indirect heat exchange, and
utilizing the steam stream in a carbon capture system, wherein the carbon capture system comprises a cryogenic partial condensation step,
wherein the carbon capture system produces a product carbon dioxide stream.

2. The heat integration method of claim 1, wherein the hot gas stream has a temperature of between 300 deg F and 935 deg F.

3. The heat integration method of claim 1, wherein the steam stream has a pressure of less than 220 psia.

4. The heat integration method of claim 1, further comprising an expansion turbine, wherein the steam stream is utilized to warm the expansion turbine in the carbon capture system.

5. The heat integration method of claim 1, further comprising an expansion turbine and a pressure swing adsorption unit, wherein the expansion turbine is downstream of the pressure swing adsorption unit.

6. The heat integration method of claim 1, further comprising an expansion turbine and a membrane separation unit, wherein the expansion turbine is downstream of the membrane separation unit.

7. The heat integration method of claim 1, wherein the cryogenic separation system comprises a cryogenic liquid stream, and wherein the steam stream is utilized to vaporize the cryogenic liquid stream.

8. The heat integration method of claim 1, further comprising a temperature swing adsorption unit, wherein the temperature swing adsorption unit utilizes a regeneration stream, and wherein the steam stream is utilized to heat the regeneration stream.

9. The heat integration method of claim 8, further comprising indirectly exchanging heat between the hot gas stream and heat exchange stream, thereby producing a hot heat exchange stream.

10. The heat integration method of claim 1, further comprising a feed gas pretreatment unit, wherein the feed gas pretreatment unit produces a treated feed gas stream, and wherein the steam stream is utilized to heat the treated feed gas stream.

11. A heat integration method, comprising:
providing a hot gas stream, wherein the hot gas stream comprises carbon dioxide and at least one gas from the following: carbon monoxide, nitrogen, and oxygen,
recovering waste heat from the hot gas stream by producing a steam stream by indirect heat exchange,
introduce the steam stream into a head absorption chiller, thereby producing a chilled water stream,
cooling the hot gas stream to less than 100 F, by utilizing at least a portion of the chilled water stream in indirect heat exchange, and by utilizing quench water in direct heat exchange, thereby producing a cooled gas stream,
introducing the cooled gas stream into a temperature swing adsorption unit, thereby producing a dried gas stream, and.
introducing the dried gas stream into a cryogenic partial condensation unit, thereby producing a product carbon dioxide stream.

12. The heat integration method of claim 11, wherein the temperature swing adsorption unit produces a desorbed regeneration gas, and wherein at least a portion of the chilled water stream is utilized in an indirect heat exchanger to cool the desorbed regeneration gas.

13. The heat integration method of claim 11, wherein at least a portion of the chilled water stream is utilized in an indirect heat exchanger to cool the quench water.

14. The heat integration method of claim 11, wherein at least a portion of the chilled water stream is utilized in an indirect heat exchanger to cool the dried gas stream prior to introduction into the cryogenic partial condensation unit.

15. The heat integration method of claim 11, further comprising a feed gas compressor upstream of the cryogenic partial condensation unit, wherein at least a portion of the chilled water stream is utilized in an indirect heat exchanger to cool a feed stream to the feed gas compressor.

16. The heat integration method of claim 11, wherein the product carbon dioxide stream is compressed, thereby producing a compressed carbon dioxide stream, wherein the compressed carbon dioxide stream is cooled in indirect heat exchange with at least a portion of the chilled water stream, thereby producing a densified carbon dioxide stream.

17. The heat integration method of claim 16, wherein the densified carbon dioxide stream is pumped to a pressure of between 75 bara and 85 bara.

18. The heat integration method of claim 16, wherein the densified carbon dioxide stream is pumped to a pressure of between 45 bara and 55 bara.
